(19) United States
(12) Patent Application Publication
(10) Pub. No.: US 2014/0024445 A1
(43) Pub. Date: Jan. 23, 2014

(54) System and Methods for Role-Playing Gaming

(71) Applicants: JARED ALLER, OAKLAND, CA (US); DAVID ALLER, LINDON, UT (US)

(72) Inventors: JARED ALLER, OAKLAND, CA (US); DAVID ALLER, LINDON, UT (US)

(21) Appl. No.: 13/747,276

(22) Filed: Jan. 22, 2013

Related U.S. Application Data
(60) Provisional application No. 61/588,848, filed on Jan. 20, 2012.

(51) Int. Cl. G07F 17/32

(52) U.S. Cl. CPC G07F 17/3225
USPC 463/29

(57) ABSTRACT

Methods and a gaming system of using a Massive Multiplayer Online Role-Playing Game based on Real Time Strategy (RTS) that incorporates a multi-level marketing element for recruiting and retaining players including a subscription based social network that rewards its users by paying them a percentage of subscription fees derived from users they directly and indirectly invite or recruit to join.

### CROSS REFERENCE OF RELATED APPLICATIONS

This application claims priority under 35 U.S.C. 119(e) to U.S. provisional patent application No. 61/588,848 filed Jan. 20, 2012, the contents of which are hereby incorporated by reference for all purposes.

### BACKGROUND OF THE INVENTION

The online, multiplayer gaming industry is one of the fastest growing industries in the world. These games include role-playing games (“RPG”) in which players take on specialized roles or virtual personas (referred to as “avatars”) and interact via the Internet with other players in simulated environments or imaginary worlds. Traditionally, a role-playing game (RPG) is a type of game in which players assume the roles of characters and collaboratively create narratives. Gameplay progresses according to a predetermined system of rules and guidelines, within which players may improvise freely. Player choices shape the direction and outcome of role-playing games.

Massively multiplayer online role-playing games (MMORPG's) have been in existence for several years. Current examples include World of Warcraft, Everquest (EQ) and Dark Age of Camelot (DAOC), among others. These games share a common structure. A single large game session is run on a host computer or server. Players use local personal computers (PC's) to log into the server through the Internet and send commands controlling a player character to game system software running on the server. The player character is represented by an animated figure that moves on a map that represents the game world, generally a simulation of a three dimensional outdoor world with occasional indoor areas. The server is a common area in which all players move, and as such there may be millions of players on that server all moving and taking actions in the same game session. These games are by nature endless or open-ended. They continue on in a steady state except when software changes are made that change game content. At some point in the game's life, players come to know the map by heart and run out of new and interesting things to do. The companies offering these games receive a monthly user fee and are thus motivated to keep subscribers entertained for as long as possible. Part of the game thus becomes how to keep users entertained while they entertain themselves. Since so much time can potentially be played in MMORPGs, much focus has been put on making the experience as interesting as possible. Thus there is a need for new ways of approaching these types of computer games.

One primary goal in a MMORPG is to increase the “power” or significance of your character. Most MMORPG's operate with a natural and incremental development of the player's character. This can happen through battles with opposing characters, finding valuable items, or completing tasks. It can take months of playing time to become a powerful character. The power of a character can be measured by the character's “level”. Higher levels are more powerful than lower levels. To achieve these higher power levels, an avatar must accumulate various attributes or assets, i.e., virtual property or character qualities, related to the game. Examples of such property may include both personal property, such as a cup, a plate, a potion, a ring, a weapon or the like, and real property, such as virtual real estate. Property may also include value items such as a quantity of gold, silver or money. Examples of such character qualities may include strength, knowledge, skill, problem solving or similar qualities or abilities. Part of the challenge of such games involves making sure that there is a sufficiently level playing field. DAOC imposes an upper limit on 50 on level advancement. Upon reaching level 50, the leveling process ends and the character is expected to move on to the frontier areas set aside for player versus player combat. This is termed “realm vs. realm” in DAOC because all players from the same realm are teamed against players from the other two realms. The mechanics of player versus player (PvP) are different from so-called player versus computer-controlled enemies (PvE). In DAOC, PvE is mostly a means to get to PvP, and level 50 characters receive no benefit other than loot from continuing in PvE. Even with such limits, many MMORPGs do not sufficiently safeguard the amount of time that can be played or how players can acquire game resources. Because of this, great disparities can develop in players. A player who initially develops more quickly by spending more time on the game or buying game resources externally will demolish and prohibit slower-developing or new characters from catching on. Furthermore, many MMORPGs don't have reasonable limits on time of play, discouraging good players from having well balanced lives. Such disparities lead to disinterest to both the expert and beginner.

Notwithstanding the qualities of one's character or the accumulation of assets, the experience one has in a MMORPG is due in large part to the size of the virtual community in which one interacts. The larger the community, the greater the opportunity to delineate one's virtual character from others and to advance. Many MMORPGs have allowed for social networking by allowing players to join clans, guilds, or groups. This allows for increased participation as each player knows or gets to know members with whom they associate in the game. The Internet serves to allow players in remote places to get together, form groups or parties, adventure together, and form in-game guild organizations. Characters gain experience to advance in level mainly by repetitive killing of enemies or other clans, which becomes tiresome even when done in parties or groups. While the social networking demand for these games continues to improve, the incentive to maintain connections remains rudimentary. Thus, there is a need to provide a system that will attract new players and encourage existing players to participate.

Exemplary implementations of described technical features attempt to solve these and other problems with such games.

### SUMMARY

Exemplary implementations of the technical features described herein include a Massive Multiplayer Online Role-Playing Game (MMORPG), based on Real Time Strategy (RTS) that incorporates a multi-level marketing element for recruiting and retaining players. At a basic level, exemplary implementations include a subscription based social network that rewards its users by paying them a percentage of subscription fees derived from users they directly and indirectly invite or recruit to join the social network. One implementation of this game is a subscription-based model, requiring a monthly fee (Y). The game encourages social networking so that additional recruits can increase the army's size and strength in battle against competing armies. New members may be directly invited by existing members of the network. New members may also be assigned to a specific existing member, if they are not directly contacted/invited by an existing member.

The game incentivizes recruiting through a multi-level marketing system that results in real-world payouts to those responsible for others that join underneath a player. An upper tier player can be a player that belongs to the same army/network or that has signed up before player0 in the same army/network. Lower tier players can be defined as those players that belong to the same army/network or who have signed up after player0 in the same army/network. Player0 is eligible for rewards for up to 5 tiers of lower tier players that have signed up underneath him. In an exemplary implementation, Player0 may recruit and receive compensation for an infinite number of player1 players. The recruiting and compensation of such recruiting for each subsequent level may be limited to 5 players per tier.

Battles are fought on a GAMING GRID against competing armies. When battles are won, the army that is victorious can take the losing armies' property. Each player (player0) exists in two armies while on the gaming grid. He exists as the head of his own army and is able to communicate and actively use his tier1 recruits to participate in the gaming grid. He also exists as a tier1 recruit in the army of the player that recruited him to participate (player1). This allows player1 to communicate with and actively use player0 while participating in the gaming grid.

The game can exist in the cloud (web) where the game database stores essential real time information to play the game. The cloud game database will be accessible on multiple front end user device platforms (EXAMPLE: iOS, Android, WebOS, PC, Macintosh, PS3, Xbox, Wii).

A key feature of the game is to create a balanced playing experience. Members of the network cannot instantaneously purchase higher-level tactical supplies, which would give them an unfair advantage. Theaters of war divide armies by experience points. This allows only players/armies of similar experience levels to attack one another, helping to balance play on the GAMING GRID.

In one preferred embodiment, the game includes a scheduled time frame of play, which limits the amount of time a person has to execute strategic moves in any 24-hour period. This feature limits enthusiasts from becoming too powerful too fast, leading to an unbalanced game experience.

Many purchases can be made using currency that only exists in the game (CREDITS). Purchases can also be made using currency that exists in game that can also be transferred to a real world currency equivalent (BULLION). This can allow for a marketplace of transactions using real-world currency to purchase virtual goods.

Outside of the basic framework of the game, there are relatively few rules to what members can or cannot do during their gaming experience.

### BRIEF DESCRIPTION OF THE DRAWINGS

FIG. 1 illustrates one embodiment of the compensation plan.

FIG. 2 illustrates one embodiment of player and army advancement.

FIG. 3 illustrates one embodiment of a gaming grid, with structure types and structures listed.

FIG. 4 illustrates different types of structures that correspond to the different Theaters of War.

FIG. 5 illustrates a building placement structure on the gaming grid.

FIG. 6 illustrates time cycles shown on the gaming grid.

### DETAILED DESCRIPTION

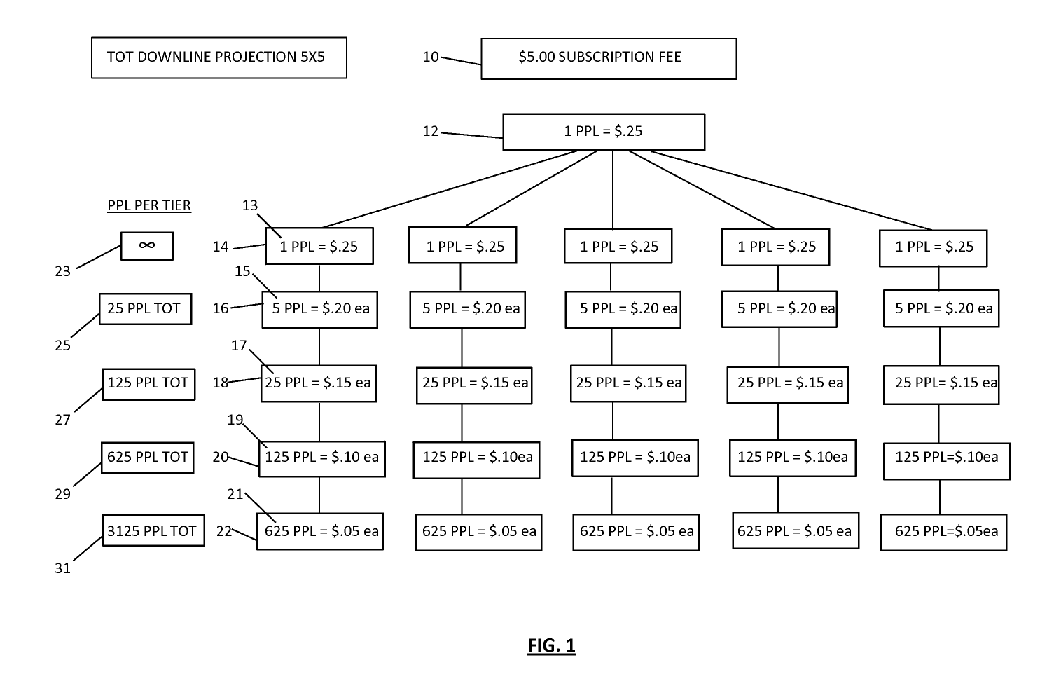

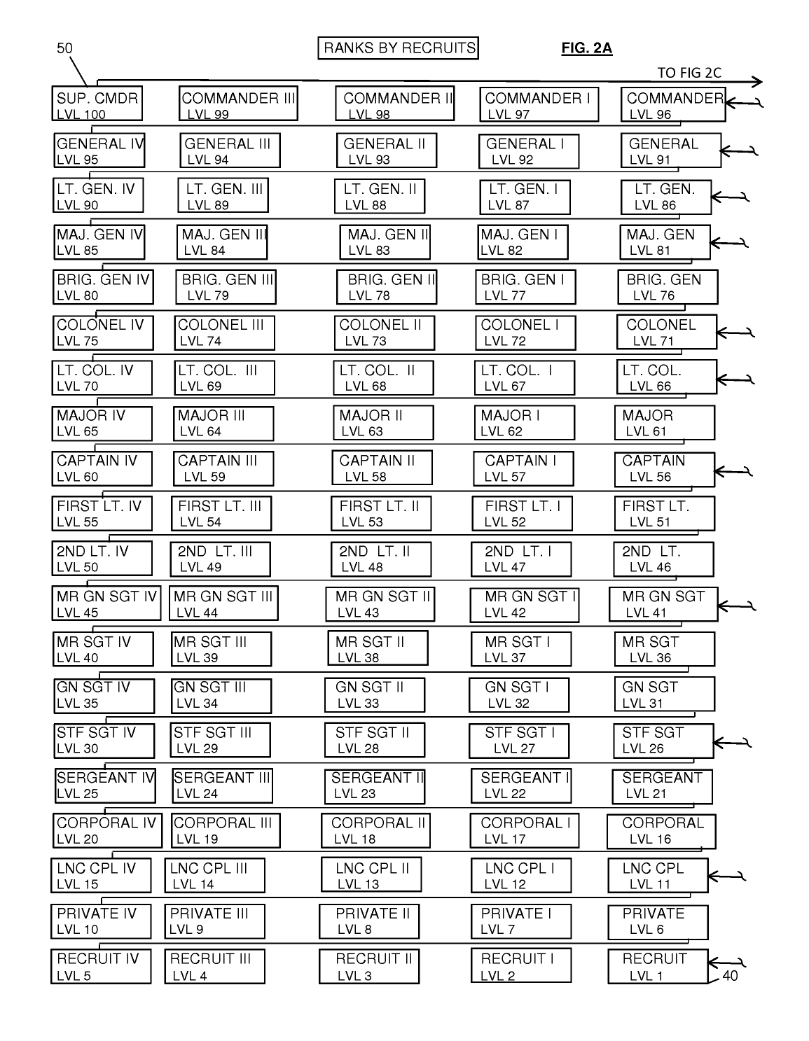

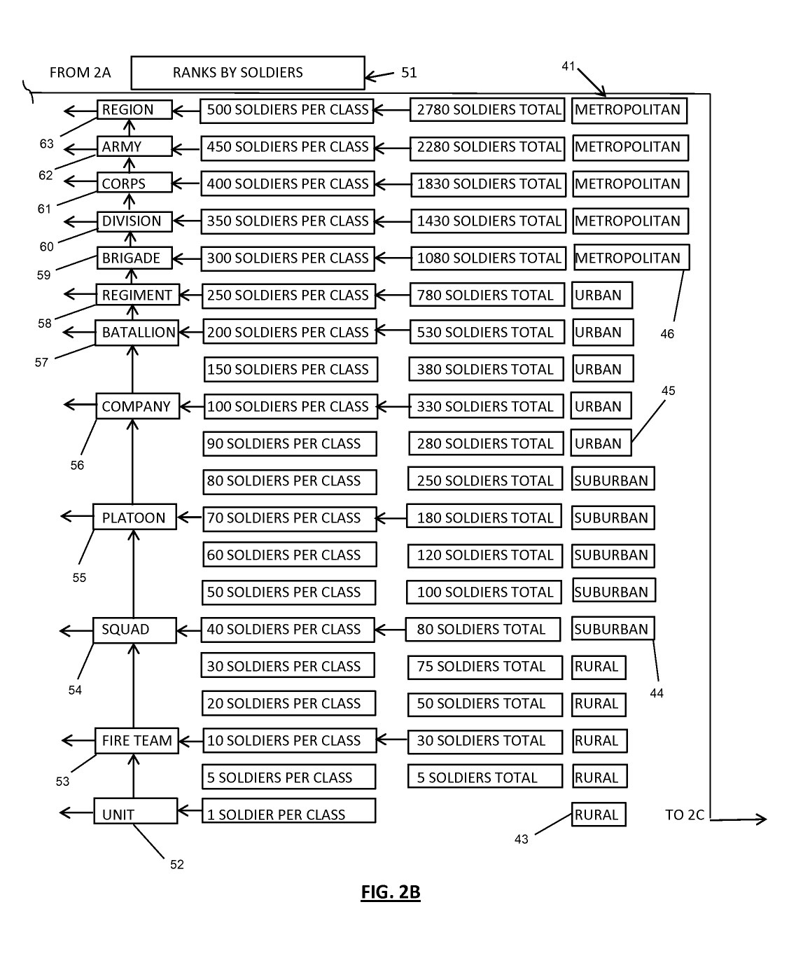

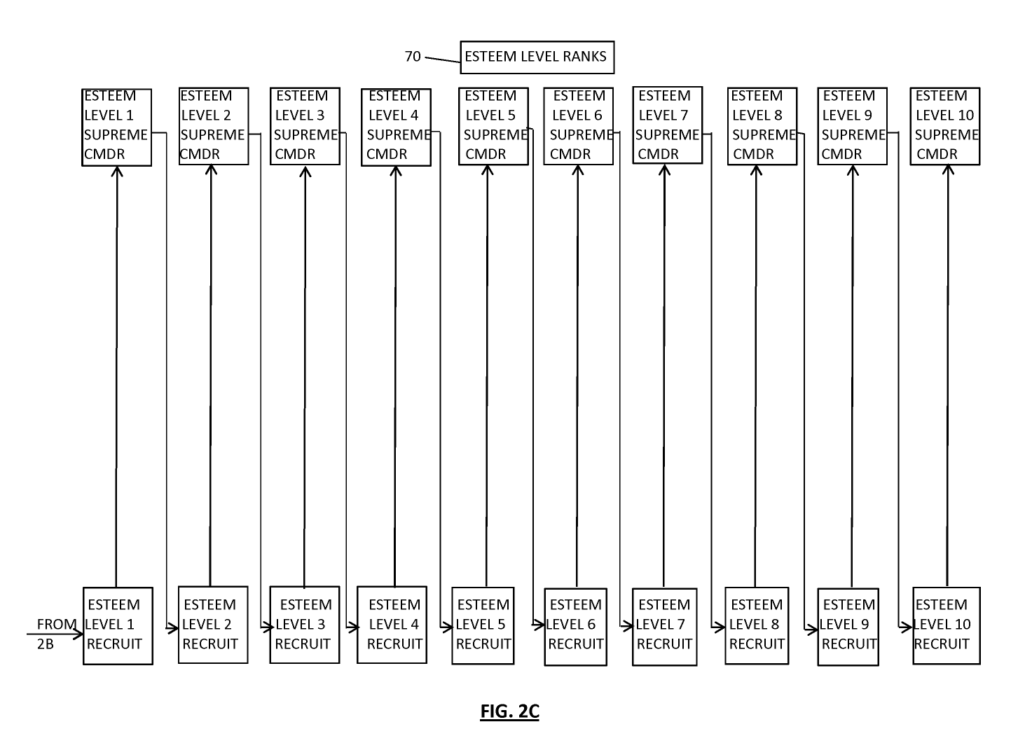

In FIG. 1, a multi-level marketing compensation plan is shown through which players receive compensation for recruiting others. An individual player 12 who registers with the game is referred to as Player0. As part of the game, Player0 must pay a subscription fee 10 on a monthly basis. This money can be counterbalanced or even reversed as he or she recruits others to play under him or her. Player0 can recruit an unlimited number of players 14 and have a fraction of those recruits' subscription fees go to Player0. For the first tier, the amount that Player0 receives from recruits can be $0.25. Player0 is further incentivized to have the recruiting process continue down the tier as each level gives a smaller fraction to Player0. Player0 can be maxed out at 25 people 25 that pay him or her on the second tier an amount of $0.20. The process continues until five tiers deep, with each level able to recruit for Player0 five times the number of the previous tier.

5 Tier Compensation Plan
Tier 1 players 14 have registered through direct contact with Player0 12.
   They have been assigned a player's id by applying Player0's id to their account.
   Player0 12 is eligible for 5% (Y×0.05) 13 of all (∞) (23) Tier1 players' subscription payments.
Tier 2 players 16 have been signed up through Tier 1 players 14.
   Player0 12 is eligible for 4% (Y×0.04) 15 of up to 25 players 25 in Tier 2 players' subscription payments.
Tier 3 players 18 have been signed up through Tier 2 players 16.
   Player0 12 is eligible for 3% (Y×0.03) 17 of up to 125 players 27 in Tier 3 players' subscription payments.
Tier 4 players 20 have been signed up through Tier 3 players 18.
   Player0 12 is eligible for 2% (Y×0.02) 19 of up to 625 players 29 in Tier 4 players' subscription payments.
Tier 5 players 22 have been signed up through Tier 4 players 20.
   Player0 is eligible for 1% (Y×0.01) 21 of up to 3125 players 31 in Tier 5 players' subscription cost

Player Advancement

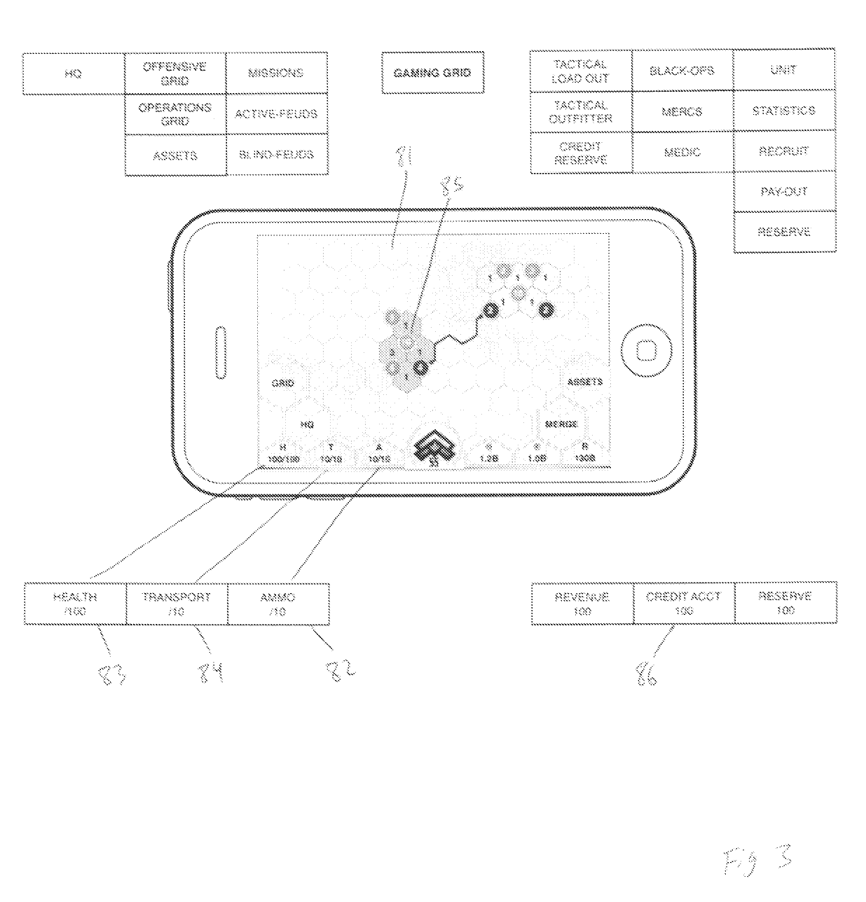

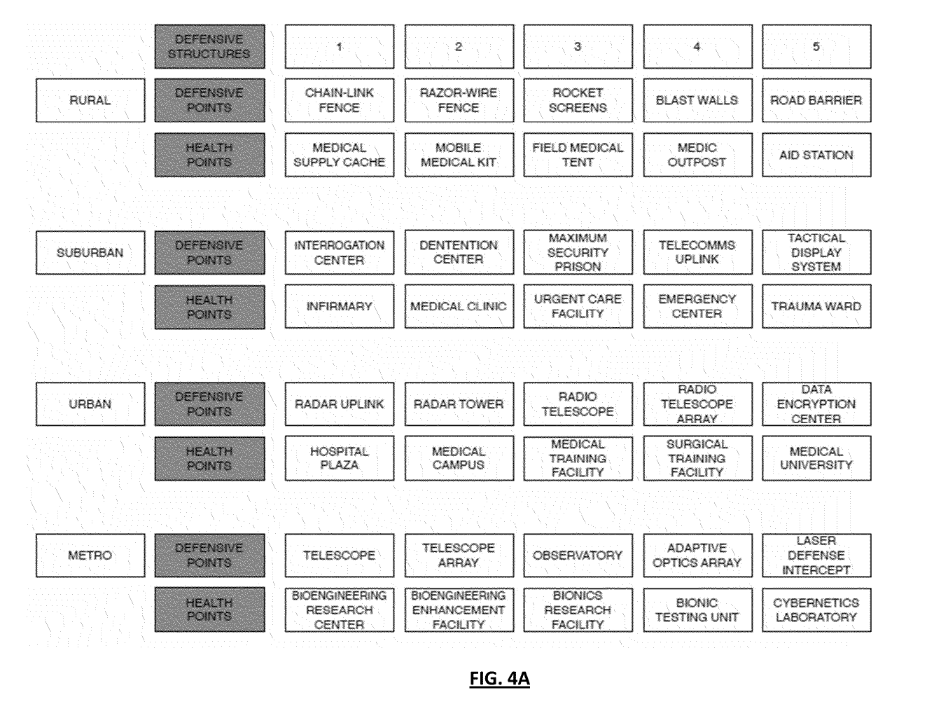

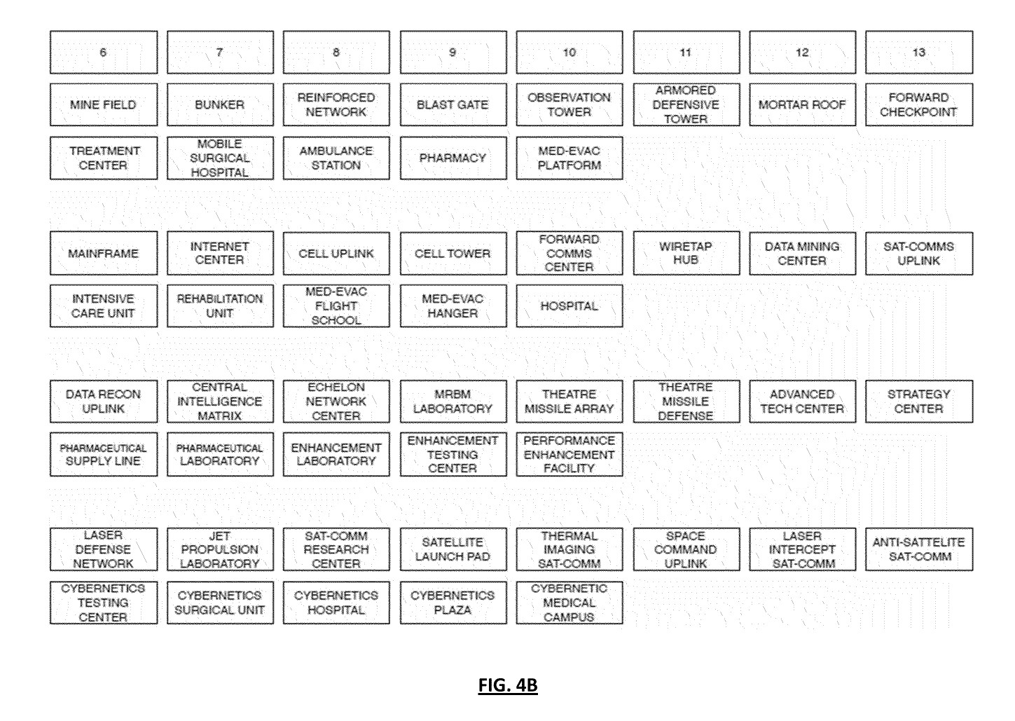

FIG. 2 illustrates one embodiment of player advancement. Player0 may start as a RECRUIT 40 and climb the ranks (100+) to the rank of SUPREME COMMANDER 50, with additional ESTEEM classes 60 (1-10×100). Each rank is obtained through experience points awarded by attacking and defending on the GAMING GRID, and by participating in different TACTICAL OPERATIONS that are separate from the GAMING GRID. As Player0 builds his experience points he will also advance his army to higher theaters of war.

The theaters of war is a grouping technique that divides armies by experience points and allows only players/armies of similar experience levels to attack one another, helping to balance play on the GAMING GRID. The more advanced the player, the higher the theater of war that player or army is in. Range is the lowest starting out level. Metropolitan is a much higher, more advanced level. Additional theaters of war are possible above and beyond Metropolitan.
THEATERS OF WAR 41
   RANGE
   RURAL 43
   SUBURBAN 44
   URBAN 45
   METROPOLITAN 46

### Army Advancement

Player0's army is comprised of lower tier players (players who have been directly recruited [tier1] and signed up after player0). The more RECRUITS Player0 recruits into his tier 1 army, the more it changes his REGIONAL COMMAND 51. A REGIONAL COMMAND 51 is made of different positions. UNIT can be the lowest REGIONAL COMMAND, and REGION is the highest.
REGIONAL COMMAND 51
   UNIT 52
   FIRE TEAM 53
   SQUAD 54
   PLATOON 55
   COMPANY 56
   BATTALION 57
   REGIMENT 58
   BRIGADE 59
   DIVISION 60
   CORP'S 61
   ARMY 62
   REGION 63

### Gaming Grid

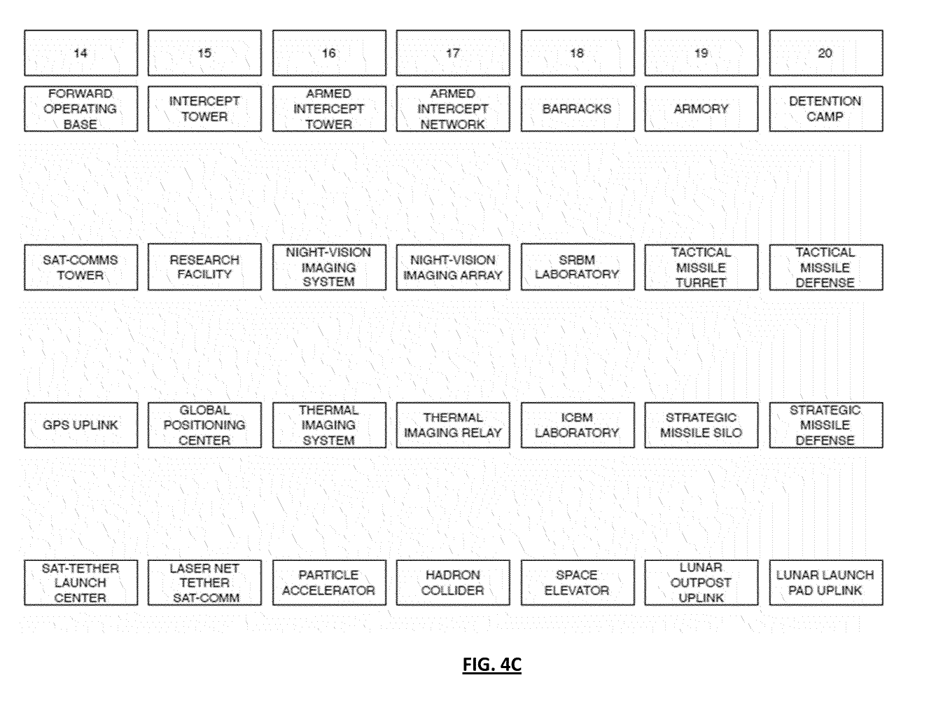

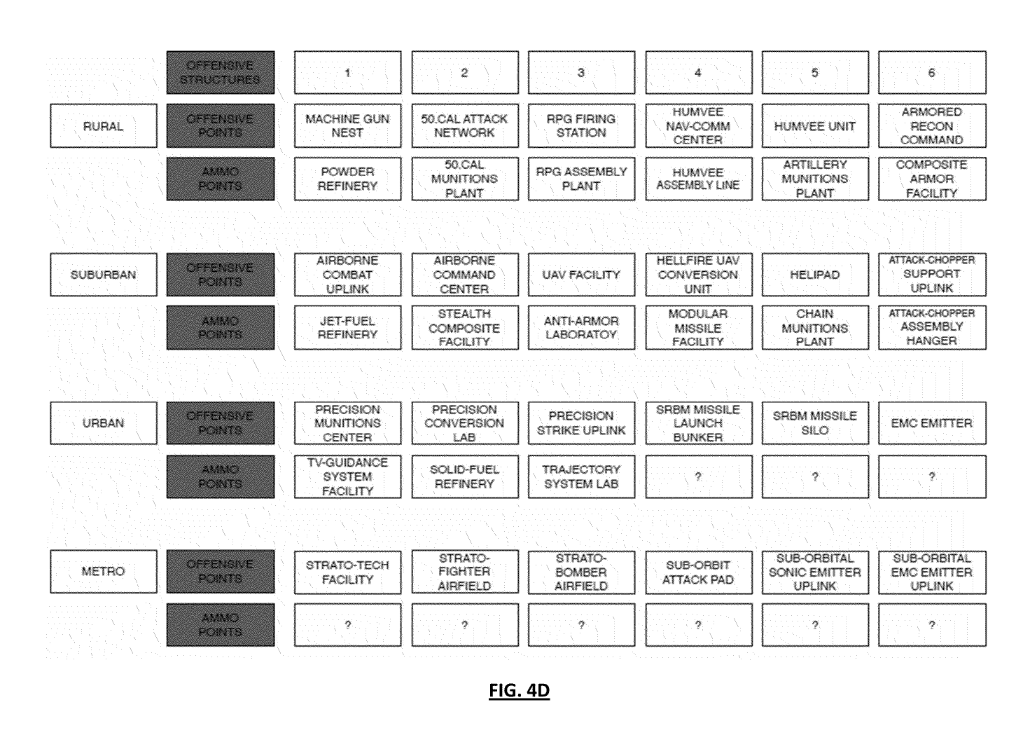

FIG. 3 illustrates one embodiment of the GAMING GRID. The GAMING GRID is the layout of the armies' territories.

Additional recruits are required to allow player0 to take over and occupy additional real estate on the GAMING GRID (LAND HEXES 81).

The GAMING GRID divides all theaters of war into hexagonal areas of occupation (LAND HEXES 81). To occupy a hex the attacking army must win a majority of 5 separate battles against a defending army. The battles are based on a percentage of the cumulative OFFENSIVE POINTS (Including Army Size, Army Tactical Outfitting, and Offensive Building Strength) vs. a percentage of the defending army's cumulative DEFENSIVE POINTS (Including Army Size, Army Tactical Outfitting, and Defensive Building Strength).

In one preferred embodiment, the ATTACKING army's attack force of 100% is divided into 5 separate percentage values for an attack.

### EXAMPLE

BATTLE 1=15% of Armies full attack force
BATTLE 2=10% of Armies full attack force
BATTLE 3=50% of Armies full attack force
BATTLE 4=15% of Armies full attack force
BATTLE 5=10% of Armies full attack force

The DEFENDING ARMY'S defending force of 100% is divided into 5 separate percentage values for defense.

### EXAMPLE

BATTLE 1=30% of Armies full defense force
BATTLE 2=30% of Armies full defense force
BATTLE 3=30% of Armies full defense force
BATTLE 4=05% of Armies full defense force
BATTLE 5=05% of Armies full defense force
In this simplified instance the Attacking army will win against the defending army.

Each hex that is taken over and occupied by player0 requires at least 1 additional recruit to occupy the space. If player0 has 5 recruits he may occupy a total of 6 land hexes (one hex per recruit including player0)

A key feature of the GAMING GRID is for player0 to plan his tactics and observe movements of his enemies. While in the game, player0 may spend as much time planning his strategy and tactics in the planning state. Once he begins to execute his strategy, he has a specific time window to finish executing his strategy and GRID attacks. Players may be attacked while they are in their planning state. It gives the player a good reason to continually monitor what is happening on the gaming grid and modify their strategy accordingly. The player decides when to use their allotted time during the 24-hour game cycle (resets each day at 12:00 midnight). In one embodiment of the invention, the allotted time the player has to use is apportioned on a use-it-or-lose-it policy—the time will not roll over to another day. Once the time window is closed, the player must wait until the round clock resets at 12:00 midnight, in his local time zone.

### Structure Purchase and Placement

Once a land hex is taken over by player0, he may begin to purchase structures 85 that can be added to the hex's vertices. The structures fall into 3 categories with 6 purposes:

Category1:
Offensive Structures: (Purposes: Obtain more Offensive Points [OFFENSIVE STRUCTURES], or Obtain more Ammunition Points [AMMUNITION STRUCTURES]) These buildings are purchased and placed at vertices of occupied hexes to build your offensive strength. Offensive Points are collected and added to the combined offensive strength of your recruited army while attacking opponents' occupied territory. Ammunition Points 82 are collected and spent while attacking opponents occupied territory. Once all the Ammunition Points 82 are spent, the attacking army will no longer be able to attack (until it has waited the necessary amount of time cycles needed to rebuild its Ammunition Point stockpile). In one preferred embodiment, both the attacker and the defender get a percentage of the salvage value (salvage value may be a percentage of the original cost of the building, for instance 60%). A portion of this salvage value may go to the attacker and a portion goes to the defender. For instance, the attacker may get 60% and the defender get 40% of the salvage value.

Category2:
Defensive Structures: (Purposes; Obtain more Defensive Points, or Obtain more Health Points) These buildings are purchased and placed at vertices of occupied hexes to build your defensive strength. The defensive strength of a defender can be comprised of the cumulative points of the army and buildings combined. Defensive Points are collected and added to the combined defensive strength of your recruited army while defending territory that you occupy. Health Points 83 are collected and spent when an attacking force is attempting to take over another player's occupied territory. Once all Health Points are spent, and the player has lost a battle to an attacking force, the attacking force will destroy buildings surrounding the defending player's occupied territory. Once all of the buildings on the hex vertices have been destroyed, the attacking player may take control of the land hex. Once the defender loses the last of the buildings on the edge of the hex that is not connected to any other hex, the defending army does not necessarily die, but is rather pushed back into another hex. In one preferred embodiment of the invention, when a player first begins the game, he is not on the Gaming Grid, but rather going through BootCamp. BootCamp is a separate Grid that you start with learning how the Grid works. Once you have completed BootCamp you “Drop In” to the actual Grid. The player can select one hex that has not been conquered and begin your campaign there. If the player loses all its hexes, he is put back up into completed BootCamp. And he can drop into the map again. This can actually be a strategic way to move across the map away from other players that are superior to the player.

Category3:
Revenue Structures: (Purposes; Obtain game currency “Credits”, or Obtain Transportation Points) These buildings are purchased and placed at the vertices of occupied hexes to build monetary revenue, and acquire Transportation Points 84. Game currency, “Credits” are collected and deposited in the players CREDIT ACCOUNT 86 after every time interval cycle is completed. The revenue building will continue to collect credits after each time cycle, as long as it remains in play on the board. If an attacking force destroys a revenue structure; it will no longer collect credits. Transportation Points 84 are collected and spent when you are traveling distances to attack an opposing force to obtain additional land hexes. Each line traveled across the game board requires 1 Transportation point. Once all Transportation Points are spent you will no longer be able to travel the distance required to attack the land hex held by the opposing force (until you have waited the necessary amount to time cycles needed to rebuild your Transportation Point stockpile).

As the game progresses structures that are purchased may be MERGED with additional cost, becoming an UPGRADED higher-level type of those structures. In one preferred embodiment, to merge, each of the structures being merged must be of the same STRUCTURE TYPE (there are 6 different structures: DEFENSIVE, HEALTH, OFFENSIVE, AMMUNITION, REVENUE, TRANSPORTATION). Once merged the multiple buildings become a higher-level type of the structure and may be placed on a single vertex of a hex, instead of residing on multiple vertices. Allowing for new buildings to be placed on the previously occupied vertices.

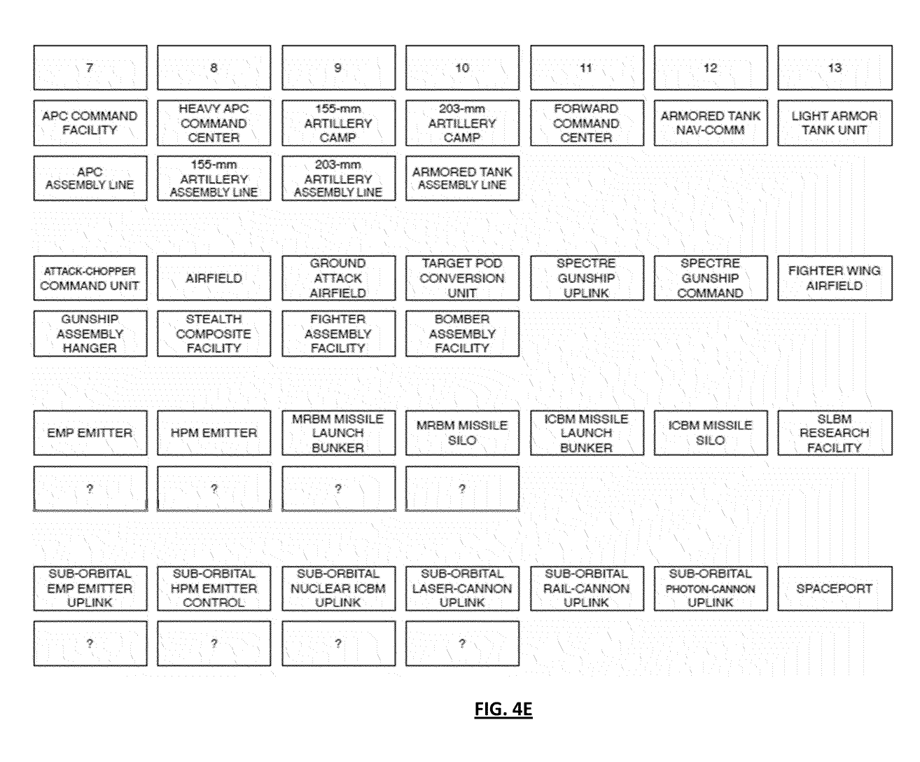

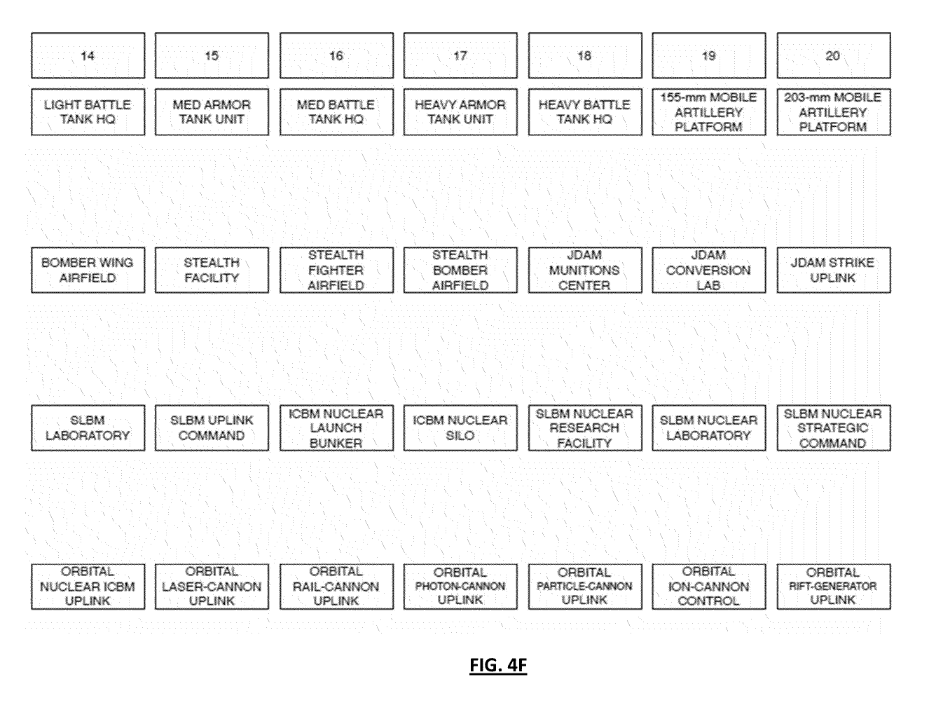

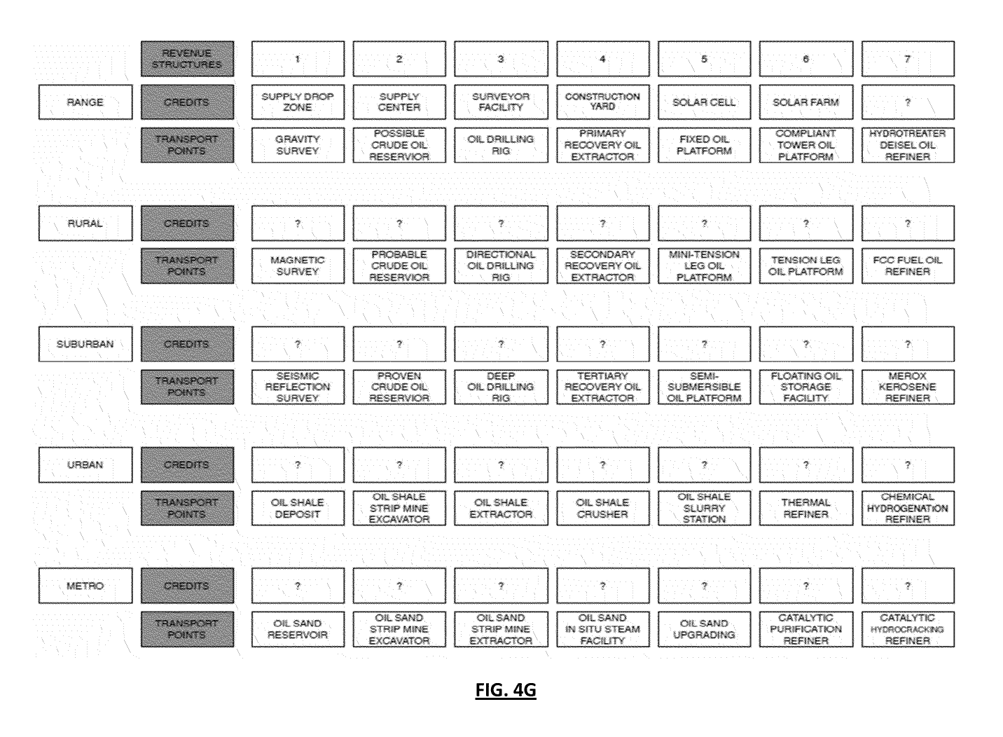

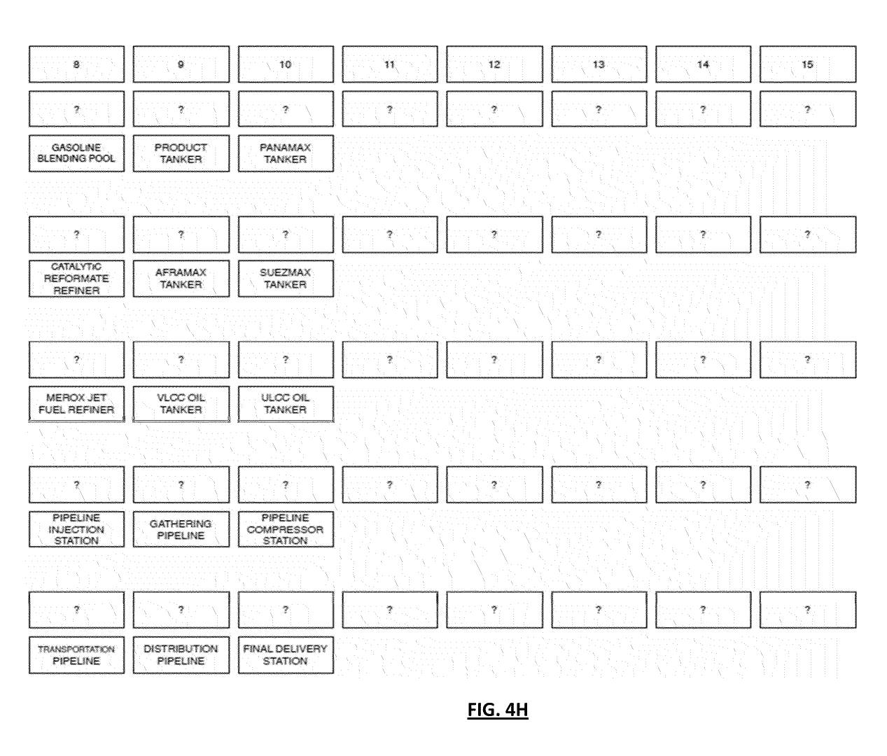

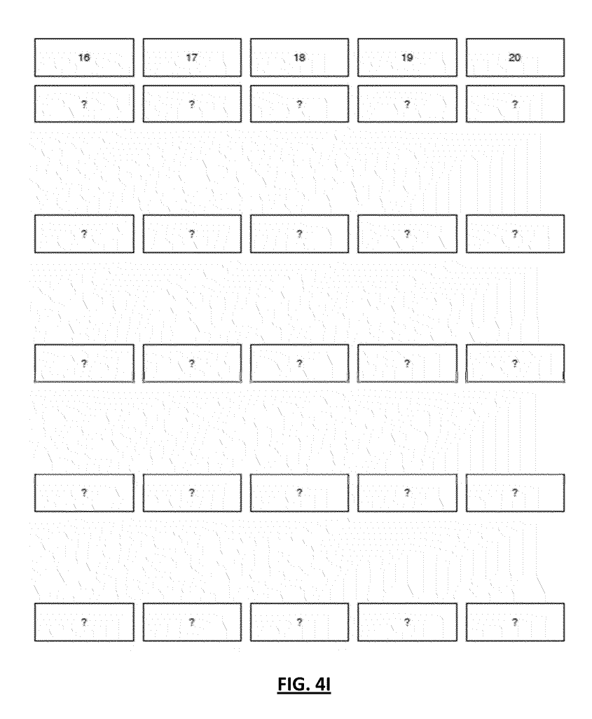

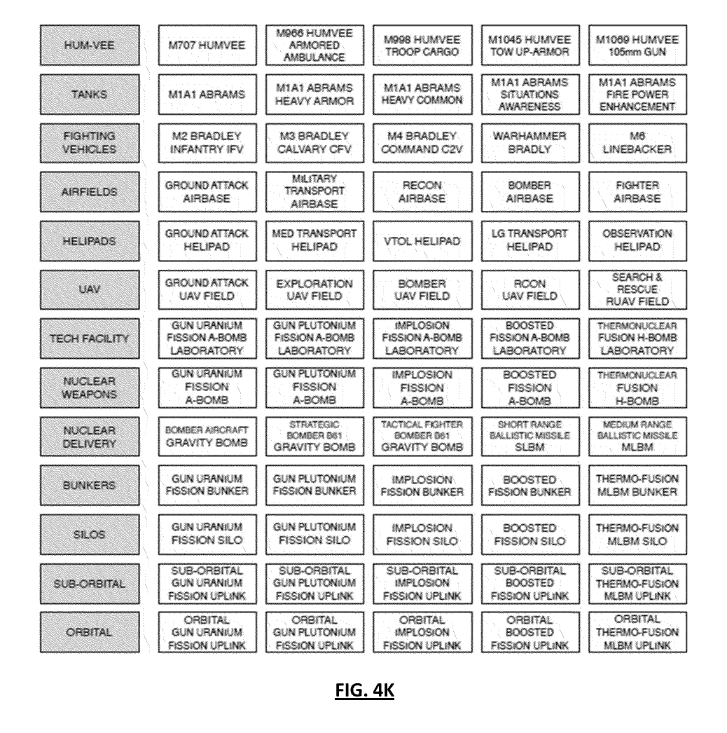

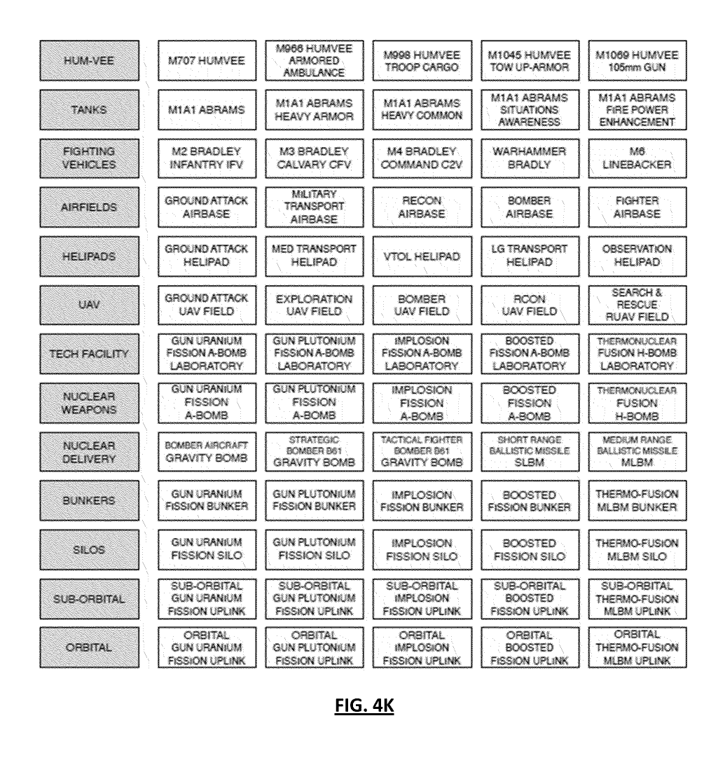

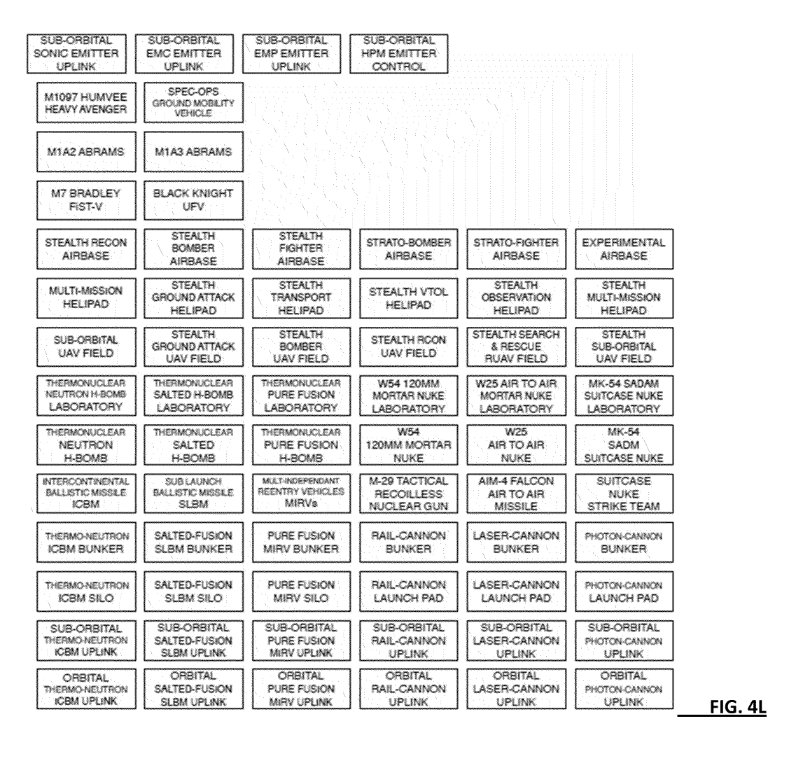

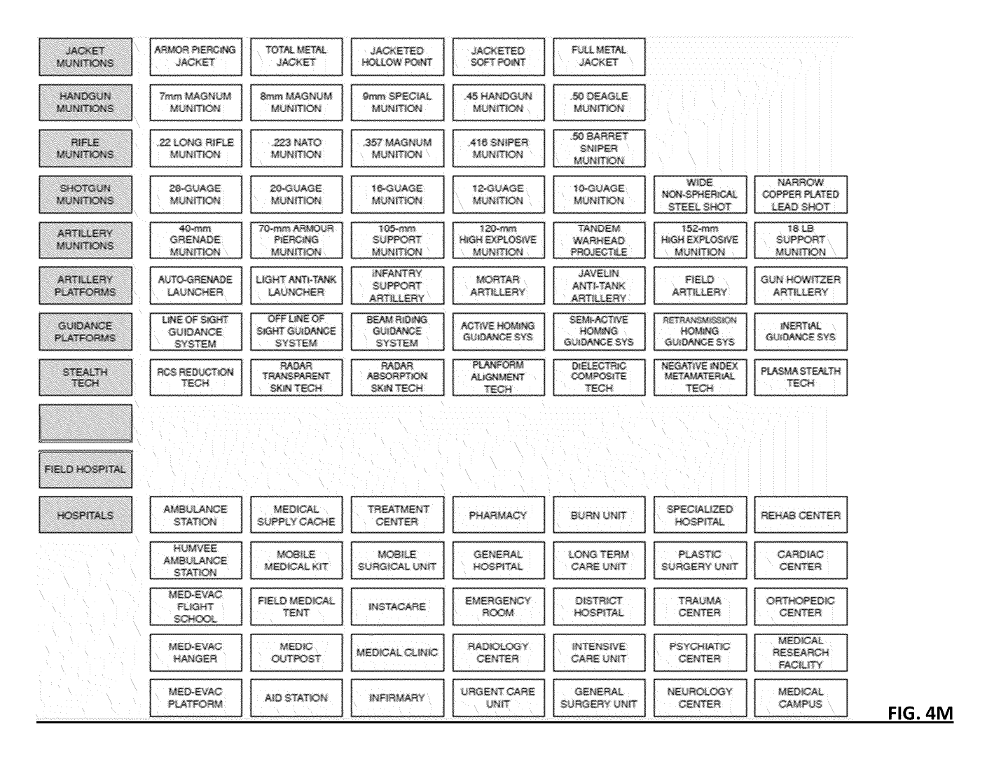

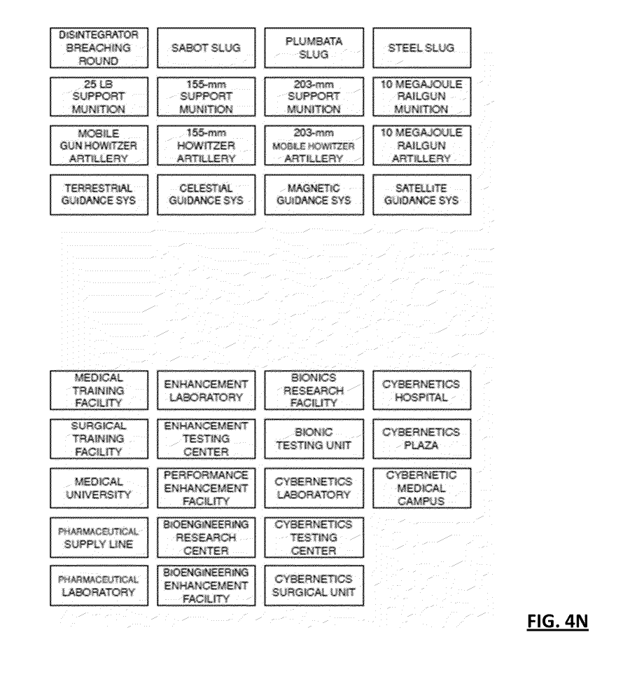

In FIG. 4, different types of structures are shown that correspond to the different Theaters of War.

In FIG. 5, a building placement structure is shown on the gaming grid.

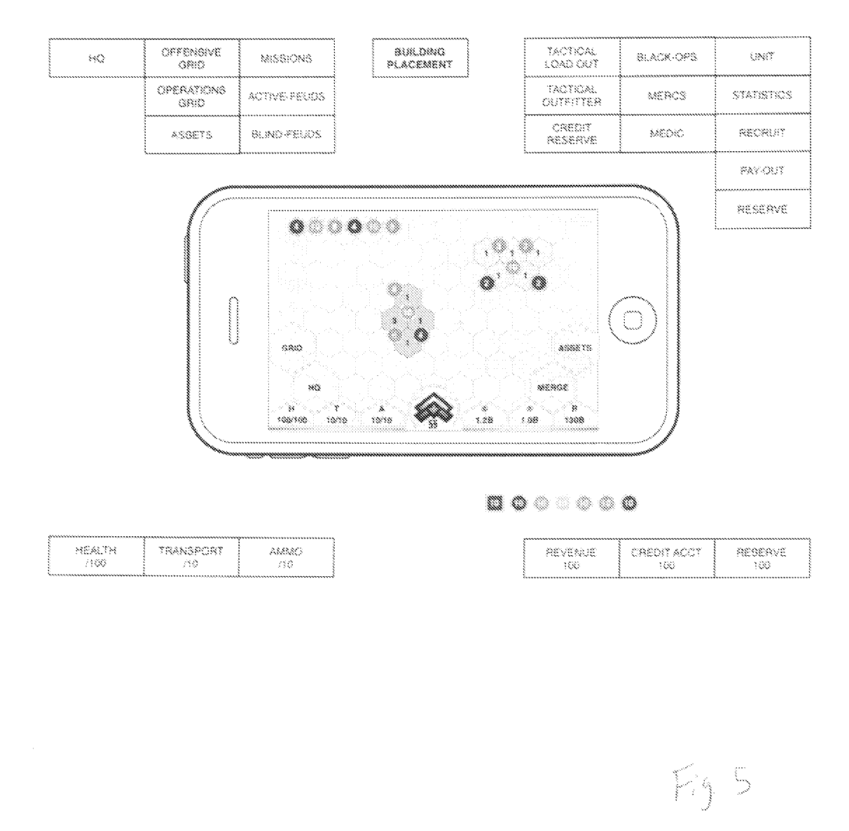

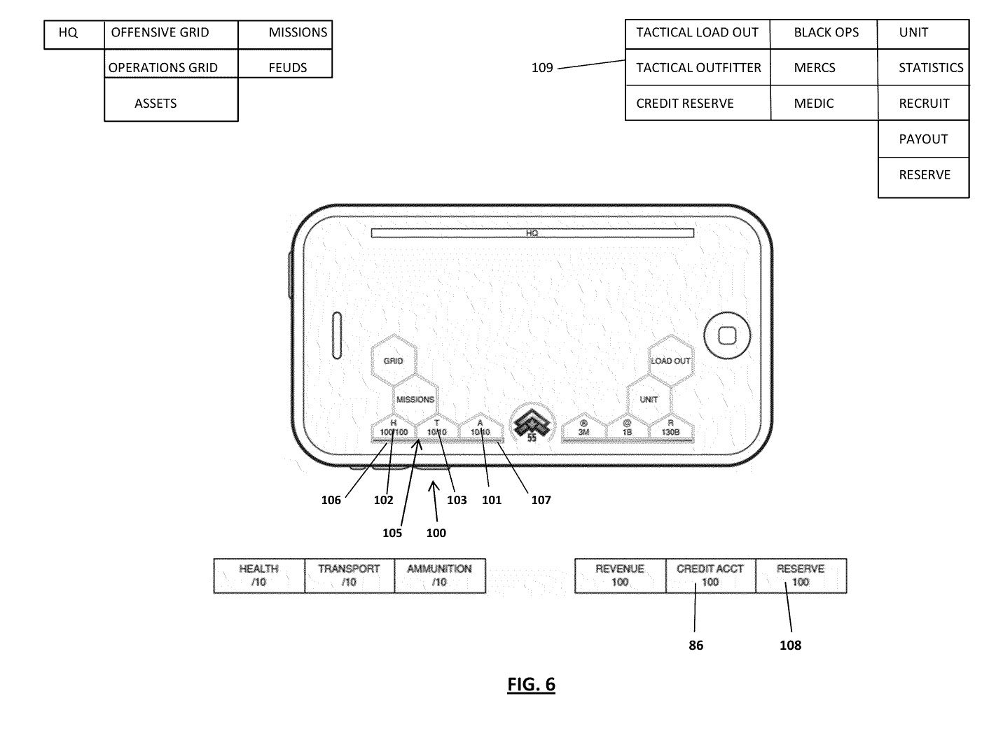

In FIG. 6, time cycles are shown on the gaming grid.

### Time Cycles

TIME CYCLES 100 are short intervals of time that can be used to replenish points used in attacking and defending. Ammunition Points 101, Health Points 102, and Transportation Points 103 are some examples of points that may be replenished through time cycles. Once these point stockpiles have been depleted each player must wait the appropriate time cycle to restock the necessary points needed to attack and defend. Each player's structures will continue to produce points according to the time cycle, even if the player's point stockpile has reached its maximum. In the game user interface the TIME CYCLE is displayed as a bar 105 that builds from RED 106 to GREEN 107 and resets as it reaches GREEN 107 at a determined time interval. As the time bar builds past each point field a point is restocked to that point field.

TIME CYCLES can also be used by REVENUE Structures. Credits can be deposited into a player's CREDIT ACCOUNT 86 at the end of each TIME CYCLE.

### Credit Account

Each Player's CREDIT ACCOUNT 86 does not have a limit, allowing for a limitless amount of credit on hand. Each player's CREDIT ACCOUNT 86 is not safely guarded and may be seized upon attack from a competing army. To keep your credit funds safe players must deposit their funds into a CREDIT RESERVE. Each player's CREDIT RESERVE is limited; once the limit is reached all additional funds will remain in the player's CREDIT ACCOUNT and may be seized upon attack from a competing army. The CREDIT RESERVE 108 charges a fee (CR %) to deposit funds, however the CREDIT RESERVE will also pay out interest (CRI) depending on the amount of funds that have remained in the vault for a determined amount of time (CRI=Median CV Balance×%).

### Bullion Reserve

Each Player's BULLION RESERVE is different from the player's CREDIT ACCOUNT/RESERVE. The BULLION RESERVE is real currency that exists in the game. Unlike the CREDIT RESERVE the BULLION RESERVE can be transferred to real currency equivalents, and can be paid out to the player. There will be multiple opportunities for players to use and expand their BULLION RESERVE in several different areas of game play, including OPERATIONS and BLACK OPERATIONS.

### Loadout Kit Classes

Player0 can change between 3 separate types of LOADOUT KITS.

Kit1: Designated as the SNIPER class. The SNIPER CLASS loadout is favored for ATTACK—weapons are powerful with long range and have a high attack value; personal body armor is light with low defensive value.

Kit2: Designated as the SPEC OPS class. The SPEC OPS loadout is favored for EQUAL defense and attack—weapons are moderately powerful with medium range and medium attack value; personal body armor is moderate with medium defensive value.

Kit3: Designated as the ASSAULT class. The ASSAULT loadout is favored for DEFENSE—weapons are moderately powerful with low range and low attack value; personal body armor is heavy with high defensive value.

Player0 may designate any one of the 3 separate LOADOUT KITS at any time, depending on the goal he is trying to accomplish on the GAMING GRID. Player0's ATTACK/DEFENSE strength is derived from the LOADOUT he is currently using, as well as Player0's Tier1 army recruits LOADOUTS. These values combined with his OFFENSIVE/DEFENSIVE Structure values make up the TOTAL OFFENSIVE/DEFENSIVE points that are used while attacking and defending of the GAMING GRID.

LOADOUT KITS are developed at the TACTICAL OUTFITTER 109. The TACTICAL OUTFITTER 109 is where player0 may purchase, with credits from his CREDIT ACCOUNT 86, additional/more powerful weapons and additional/heavier personal body armor to better equip each designated soldier class. Other various tactical gear may be purchased to outfit a LOADOUT KIT at the TACTICAL OUTFITTER. Many of these will require payment from player0's BULLION RESERVE, which is real currency that exists in the game. These upgrades are purely aesthetic and have no affect on the LOADOUT KITS OFFENSIVE/DEFENSIVE capabilities.

### Operations

GLOBAL BONUS POOLS are operations, launched quarterly, developed for the players that require a number of steps to complete, and involve all aspects of the game. An Operation is a set of objectives that need to be accomplished over a defined period of time. For example, one operation can include taking over 3 hexes and holding them for 48 hours. Or, for instance, finding a special hex (defined by color or something else). Once a hex is captured, everyone within a defined area is alerted to you finding it. Defend the hex for 24 hours. Once the objectives are accomplished, the player receives the pre-determined award, for instance, like a structure or a more powerful weapon. An operation can include assassinating certain people in Black OPS or taking a specific amount of land and holding it for a predetermined amount of time. If a single player is able to accomplish the operation, he/they will qualify for the GLOBAL BONUS POOL. In another embodiment, a single player may accomplish the operation with the aid of his direct recruits, depending on whether the player wants the help or not. This will enlarge the percentage of payout from their recruit pool for a specific amount of time. In one preferred embodiment, the operations to accomplish can change every time a new GLOBAL BONUS POOL is initiated.

THE WESTING GAME is based on an operation initiated once a year with a large monetary value that requires a large amount of time to complete. It is puzzle-based and involves all aspects of the game. If a single player is able to solve the puzzle and accomplish all the tasks required for THE WESTING GAME (or is able to accomplish with the aid of his direct recruits) he/they will win the value of the prize singularly/or to be divided up among his recruits, and deposited in the BULLION RESERVE.

### Black Operations

BLACK OPERATIONS (BLACK OPS) are special missions that are played one player vs. one player. BLACK OPS are a variety of mini games that reside outside of the GAMING GRID. Players opt into and accept challenges from other players to participate in BLACK OPS. When participating in BLACK OPS, players do not collect winnings from the CREDIT RESERVE; they will use their BULLION RESERVE. Players may offer up ransoms in the BLACK OPERATIONS—and if the BLACK OP is completed, the player who completes the task receives the payout.

### Implementation

Exemplary implementations can exist in the cloud (web) where the game's database will store all essential real time information to play the game. The cloud game database will be accessible on multiple front end user device platforms (EXAMPLE: iOS, Android, WebOS, PC, Macintosh, PS3, Xbox, Wii). Exemplary implementations may be built off of web-based languages, where a client device can access server data, as feasible. The system can handle the graphics, which allow for designing the front-end in the client systems native language; then have it access the backend information via the web. If each system cannot read the web-based backend, we can also figure out a way to have the same information updated and duplicated across multiple servers, running multiple back-end system clients (for specified front end clients) that are updated in their language-specific code translated from other code/master code.

What is claimed is:

1. A method for operating an online subscription-based role playing game comprising the steps of:
registering a first level individual for participation in the online subscription-based role playing game, wherein the registering includes assigning a game identity to the first level individual and providing at least one attribute to the online game for use in the online game, the first level individual paying a monthly fee to participate in the online game;
registering at least one second level individual for participation at the online game, the registering including assigning a game identity to the second level individual, providing at least one attribute to the game identity for use in the online game, the first level individual paying a monthly fee to participate in the online game, the second level individual being referred to the online game by the first level individual;
providing the first level individual a portion of the subscription fees of the at least one second level individual based upon completion of the registration of the at least one second level individual; and
providing the first level individual army support from the at least one second level individual.

2. The method of claim 2, further comprising the step of monitoring the recruitment of the second level individual at said online game.

3. The method of claim 2, further comprising the steps of:
defining three different levels of participation of the first level individual in the online game and associating an attribute number to each defined level of participation, wherein each defined level of participation contains a portion of subscription fees value;
based on the monitoring, determining the recruitment activity of the second level individual, wherein a recruit of the second level individual corresponds to an at least one third level individual, each second level individual corresponding to at least one third level individual and not exceeding five third level individuals;
providing the first level participant with a portion of the proceeds of the subscription fees from the at least one third level individuals; and
providing the first level individual army support from the at least one third level individual.

4. The method of claim 3 further comprising the step of monitoring the recruitment of the third level individual at the online game.

5. The method of claim 4, further comprising the steps of:
defining four different levels of participation of said first level individual at said online game and associating an attribute number to each defined level of participation, wherein each defined level of participation contains a portion of subscription fees value;
based on the monitoring, determining the recruitment activity of the third level individual, wherein a recruit of the third level individual corresponds to an at least one fourth level individual, wherein the at least one fourth level individual does not exceed five for each third level individual;
providing the first level participant with a portion of the proceeds of the subscription fees from the at least one fourth level individual; and
providing the first level individual army support from the at least one fourth level individual.

6. The method of claim 5 further comprising the step of monitoring the recruitment of said fourth level individual at the online game.

7. The method of claim 6, further comprising the steps of:
defining five different levels of participation of the first level individual at the online game and associating an attribute number to each defined level of participation, each defined level of participation containing a portion of subscription fees value;
based on the monitoring, determining the recruitment activity of the fourth level individual, wherein a recruit of the fourth level individual corresponds to an at least one fifth level individual, the fourth level individual not corresponding to more than five fifth level individuals;
providing the first level participant with a portion of the proceeds of the subscription fees from the at least one fifth individual; and
providing the first level individual army support from the at least one fifth level individual.

8. An online gaming system comprising:
a memory storing instructions that when executed are capable of operating an online computer network to run a game executable stored thereon;
a server enabled to communicate with the memory and connected to the online computer network;
a gaming grid made up of a plurality of hexes;
theaters of war, helping to balance play on the gaming grid, wherein the theaters of war occupy some of the plurality of hexes; and
at least one army capable of occupying at least one hex, wherein the at least one army is comprised of a player and his recruits.

9. The online gaming system of claim 8 further comprising loadout kits for the player.

10. The online gaming system of claim 9 further comprising a credit account and a bullion reserve for the player to manage the at least one army on the gaming grid.

11. The online gaming system of claim 10 further comprising time cycles used to replenish army points.

12. The online gaming system of claim 8 wherein the plurality of hexes is capable of building structures on for defense, attack, and revenue.

13. The online gaming system of claim 12 wherein the building structures are capable of being merged into upgraded structures.

14. The online gaming system of claim 8 wherein a hex from the plurality of hexes is capable of being conquered based on a five-match battle.

15. The online gaming system of claim 8 wherein the at least one army is capable of advancing to a plurality of levels.

16. The online gaming system of claim 15 wherein the player is capable of advancing to a plurality of levels.

17. The online gaming system of claim 8 further comprising operations for the player to engage in.

18. The online gaming system of claim 17 wherein the operations comprise black operations.
